(19) United States
(12) Patent Application Publication
(10) Pub. No.: US 2018/0227050 A1
(43) Pub. Date: Aug. 9, 2018

(54) FREE SPACE OPTICAL COMMUNICATION

(71) Applicant: Sensors Unlimited, Inc., Princeton, NJ (US)

(72) Inventor: Jonathan Nazemi, Doylestown, PA (US)

(21) Appl. No.: 15/427,608

(22) Filed: Feb. 8, 2017

(51) Int. Cl. H04B 10/11; H04B 10/50; H04B 10/66; H04L 7/00

(52) U.S. Cl. CPC H04B 10/11; H04L 7/0075; H04B 10/66; H04B 10/503

(57) ABSTRACT

A method of free space optical communication includes receiving a pulsed optical signal through free space, wherein the pulsed optical signal is received by a receiver device from a laser source device. The method includes decoding the pulsed optical signal in the receiver device, wherein decoding is performed asynchronously with respect to the laser source device. Receiving can include receiving the pulsed optical signal from a reflection of the laser source device when direct line of sight between the receiver device and the laser source device is unavailable. Decoding the pulsed optical signal can include decoding a communication that includes at least one of text, voice, or data.

### BACKGROUND OF THE INVENTION

### 1. Field of the Invention

The present disclosure relates to communication systems and methods, and more particularly to optical communication in free space even when only an indirect line of sight is available.

### 2. Description of Related Art

Traditional laser-based free space optical communications require a clear line of sight between the laser source and the receiver. This can present a challenge when there is no line of sight available due to environment, objects entering the space, or atmospheric conditions such as fog.

The conventional techniques have been considered satisfactory for their intended purpose. However, there is an ever present need for improved free space optical communications. This disclosure provides a solution for this problem.

### SUMMARY OF THE INVENTION

A method of free space optical communication includes receiving a pulsed optical signal through free space, wherein the pulsed optical signal is received by a receiver device from a laser source device. The method includes decoding the pulsed optical signal in the receiver device, wherein decoding is performed asynchronously with respect to the laser source device.

Receiving can include receiving the pulsed optical signal from a reflection of the laser source device when direct line of sight between the receiver device and the laser source device is unavailable. Decoding the pulsed optical signal can include decoding a communication that includes at least one of text, voice, or data.

The laser source device and the receiver device can be free of laser line filters. The receiver device and the laser source device can be free of any synchronized external and internal clock sources. The receiver device and the laser source device can be free of physical shutters to modulate the signal.

The receiver device and the laser source device can be in separate locations observing a common target. The method can include displaying the pulsed optical signal overlaid on an image of the target. It is also contemplated that the method can include displaying indicia of a communication associated with the pulsed optical signal.

Receiving a pulsed optical signal can include the receiver device receiving a plurality of pulsed optical signals through free space, wherein each of the pulsed optical signals are received from a separate respective laser source device, and wherein each respective pulsed optical signal may or may not be on a separate pulse frequency, and wherein decoding the pulsed optical signal in the receiver device includes decoding the plurality of optical signals asynchronously with respect to the laser source devices. Receiving can include receiving the pulsed optical signals from respective reflections illuminated by the laser source devices when direct line of sight between the receiver device and the laser source devices is unavailable. Decoding can include decoding each of the pulsed optical signals as a separate communications channel. The receiver device and the laser source devices can be in separate locations, wherein each laser source device is observing a respective target that is also observed by the receiver device. The method can include displaying each respective pulsed optical signal overlaid on an image that includes each of the respective targets. It is also contemplated that the method can include displaying indicia of a respective communication associated with each pulsed optical signal.

An optical communication receiver device includes an optical receiver component configured to receive at least one pulsed optical signal through free space, wherein the at least one pulsed optical signal is received from at least one laser source device. A module is operatively connected to the optical receiver component. The module is configured to decode data encoded in the at least one pulsed optical signal from the receiver component, wherein decoding is performed asynchronously with respect to the at least one laser source device.

The at least one pulsed optical signal can be a plurality of pulsed optical signals from a plurality of laser source devices. A display can be operatively connected to the module, wherein the module and display are configured to display the pulsed optical signal overlaid on an image of the target observed by both the optical receiver component and the laser source device. The display and module can be configured to display indicia of a communication associated with the pulsed optical signal.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic view of an exemplary embodiment of a system constructed in accordance with the present disclosure, showing a receiver device receiving free space optical communications from multiple laser source devices without line of sight; and

FIG. 2 is a schematic view of a display of the receiver device of FIG. 1, showing multiple pulsed optical signals overlaid on an image of the respective targets observed by both the receiver device and the respective laser source devices.

### DETAILED DESCRIPTION OF THE PREFERRED EMBODIMENTS

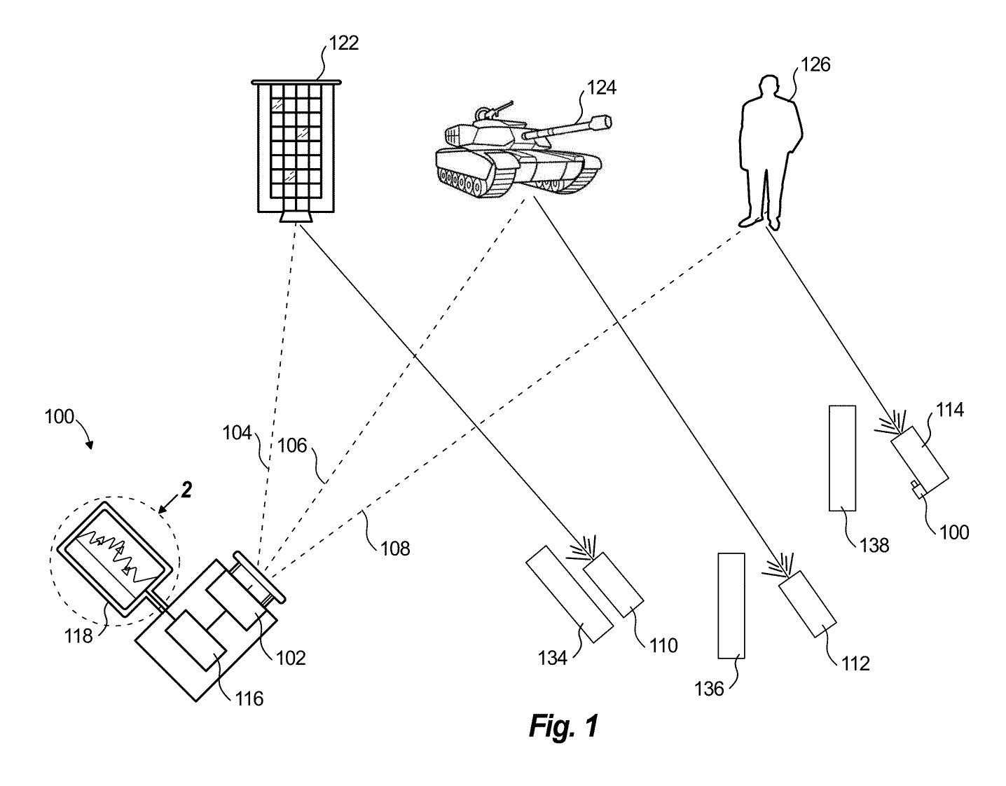

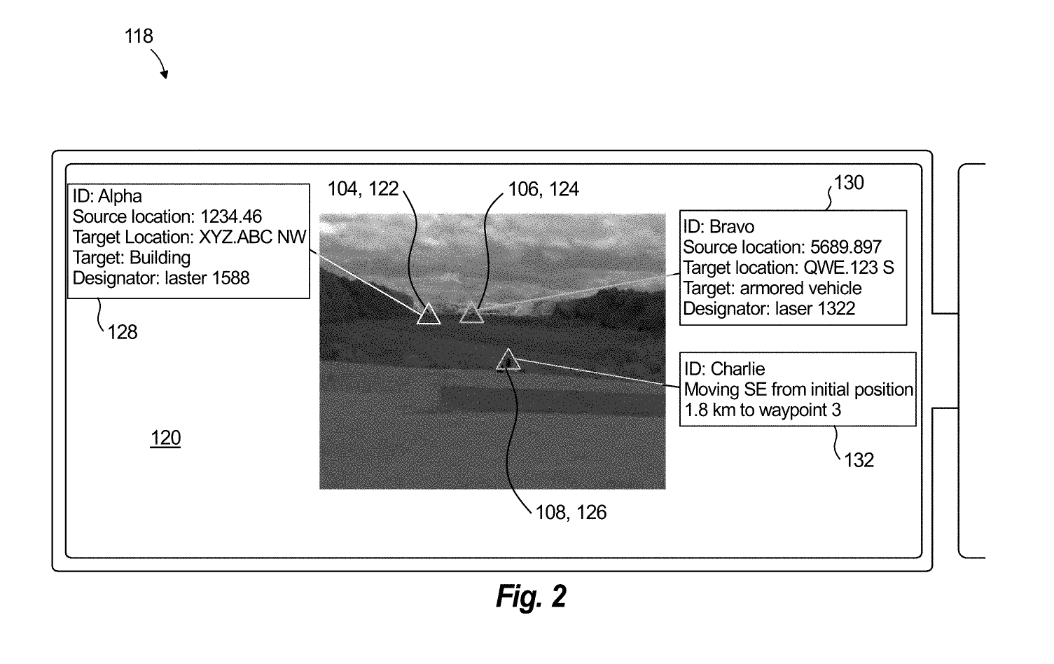

Reference will now be made to the drawings wherein like reference numerals identify similar structural features or aspects of the subject disclosure. For purposes of explanation and illustration, and not limitation, a partial view of an exemplary embodiment of a device in accordance with the disclosure is shown in FIG. 1 and is designated generally by reference character 100. Other embodiments of devices in accordance with the disclosure, or aspects thereof, are provided in FIG. 2, as will be described. The systems and methods described herein can be used for free space optical communication without line of sight.

Optical communication receiver device 100 includes an optical receiver component 102 configured to receive one or more pulsed optical signals 104, 106, 108 through free space, wherein the pulsed optical signals 104, 106, 108 are received from respective laser source devices 110, 112, 114. A module 116 is operatively connected to the optical receiver component 102. The module 116 is configured to decode data encoded in the pulsed optical signals from the receiver component 102, wherein decoding is performed asynchronously with respect to the laser source devices 110, 112, and 114. Those skilled in the art will readily appreciate that while shown and described in the exemplary context of having three laser source devices, any suitable number greater, equal, or less than three laser source devices can be used without departing from the scope of this disclosure.

With reference now to FIG. 2, a display 118 is operatively connected to the module 116, wherein the module 116 and display 118 are configured to display the pulsed optical signals 104, 106, 108 overlaid on an image of the target or targets, e.g. wherein the image includes the scenery and targets shown on screen 120 of display 118, wherein the targets are observed by both the optical receiver component 102 and the laser source devices 110, 112, 114 shown in FIG. 1. The example targets shown in FIG. 1 are a building 122, an armored vehicle 124, and a person 126. The display 118 and module 116 (shown in FIG. 1) can be configured to display indicia of a communication associated with the pulsed optical signals. In FIG. 2, the indicia are the triangles overlaying the image of the scenery and targets 122, 126, 126, and the indicia include the lead lines leading from the triangles to respective text boxes 128, 130, and 132 for each of the respective laser pulses 104, 106, and 126. The text boxes 128, 130, and 132 show the decoded communications received from the respective laser pulses 104, 106, and 126. Note that laser source device 114 is combined in a common device with an optical communication receiver device 100. If all source devices and receiver devices are in combined unites as in laser source device 114, all of the devices can communicate with one another using methods as described herein.

A method of free space optical communication includes receiving one or more pulsed optical signals through free space, e.g. laser pulses 104, 106, and 126, wherein the pulsed optical signals are received by a receiver device, e.g., receiver device 100, from one or more laser source devices, e.g., laser source devices 110, 112, and 114. The method includes decoding the pulsed optical signal in the receiver device, wherein decoding is performed asynchronously with respect to the laser source device.

Device 100 operates in a high speed asynchronous sampling mode. In this device, asynchronous sampling is relative to the laser pulse source or sources which do not need to be synchronized with receiver 100. Device 100 samples at a known clock rate such that the period between samples is known. Device 100 is configured to provide a binary map indicating a ‘1’ where laser pulses have been detected. Device 116 may consist of an field programmable gate array (FPGA) or computational device in which real-time signal analysis is performed to spatially and temporally isolate the detected pulses from different laser sources. Collecting these binary maps at a high sampling frequency produces a binary temporal signal that may be representative of an expected data format. Optical filters are not required, as the system detection is not reliant upon laser source wavelength. Optical shutters are not required, as the system is designed to operate without regard to synchronized timing between the laser source and receiver.

Receiving can include receiving the pulsed optical signal from a reflection, e.g., off of targets 122, 124, and 126 as shown in FIG. 1, illuminated by the laser source devices when direct line of sight between the receiver device and the laser source device is unavailable. In FIG. 1, the solid portions of the lines for pulsed optical signals 104, 106, and 108 represent the beam from the laser source devices 110, 112, and 114, respectively, before reflection, and the dotted portions indicate the reflected portion of the beams received at receiver device 100. For example in FIG. 1, obstacles 134, 136, and 138 deny direct line of sight from laser sources 110, 112, and 114, respectively. Other things that can deny direct line of sight include vegetation or other environmental factors, fog, smoke or the like. Decoding the pulsed optical signal can include decoding a communication that includes at least one of text, voice, or data, e.g. as shown in the text boxes 128, 130, and 132 of FIG. 2.

The laser source devices and the receiver device can be free of laser line filters, e.g., they operate to communicate with wavelength independence. The receiver device and the laser source devices can be free of any synchronized external and internal clock sources. The receiver device and the laser source device can be free of physical shutters to modulate the signal.

The receiver device and the laser source devices can be in separate locations, wherein each laser source device and the receiver device observe a common respective target. The method can include displaying the pulsed optical signal overlaid on an image of the target, as shown in FIG. 2. It is also contemplated that the method can include displaying indicia of a communication associated with the pulsed optical signal, as also shown in FIG. 2.

Receiving a pulsed optical signal can include the receiver device receiving a plurality of pulsed optical signals through free space, wherein each of the pulsed optical signals are received from a separate respective laser source device, and wherein each respective pulsed optical signal may or may not be on a separate pulse frequency, and wherein decoding the pulsed optical signal in the receiver device includes decoding the plurality of optical signals asynchronously with respect to the laser source devices. Receiving can include receiving the pulsed optical signals from respective reflections illuminated by the laser source devices when direct line of sight between the receiver device and the laser source devices is unavailable. Decoding can include decoding each of the pulsed optical signals as a separate communications channel.

As will be appreciated by one skilled in the art, aspects of the present embodiments may be embodied as a system, method or computer program product. Accordingly, aspects of the present embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in a flowchart and/or block diagram block or blocks.

The methods and systems of the present disclosure, as described above and shown in the drawings, provide for non-line of sight free space optical communications with superior potential properties relative to traditional systems including provision for multiple communication channels and improved display of the same to users, and no need for internal/external clock synchronization for the receiver device, no need for laser synchronization, no need for an external timing device, and no need for optical filters or shutters for synchronized modulation. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A method of free space optical communication comprising:
receiving a pulsed optical signal through free space, wherein the pulsed optical signal is received by a receiver device from a laser source device; and
decoding the pulsed optical signal in the receiver device, wherein decoding is performed asynchronously with respect to the laser source device.

2. The method as recited in claim 1, wherein the receiving includes receiving the pulsed optical signal from a reflection of the laser source device when direct line of sight between the receiver device and the laser source device is unavailable.

3. The method as recited in claim 1, wherein the laser source device and the receiver device are free of laser line filters.

4. The method as recited in claim 1, wherein the receiver device and the laser source device are free of any synchronized external and internal clock sources.

5. The method as recited in claim 1, wherein the receiver device and the laser source device are free of physical shutters to modulate the signal.

6. The method as recited in claim 1, wherein decoding the pulsed optical signal includes decoding a communication that includes at least one of text, voice, or data.

7. The method as recited in claim 1, wherein the receiver device and the laser source device are in separate locations observing a common target.

8. The method as recited in claim 7, further comprising displaying the pulsed optical signal overlaid on an image of the target.

9. The method as recited in claim 8, further comprising displaying indicia of a communication associated with the pulsed optical signal.

10. The method as recited in claim 1, wherein the receiving a pulsed optical signal includes the receiver device receiving a plurality of pulsed optical signals through free space, wherein each of the pulsed optical signals are received from a separate respective laser source device, and wherein each respective pulsed optical signal may or may not be on a separate pulse frequency, and wherein decoding the pulsed optical signal in the receiver device includes decoding the plurality of optical signals asynchronously with respect to the laser source devices.

11. The method as recited in claim 10, wherein the receiving includes receiving the pulsed optical signals from respective reflections illuminated by the laser source devices when direct line of sight between the receiver device and the laser source devices is unavailable.

12. The method as recited in claim 10, wherein decoding includes decoding each of the pulsed optical signals as a separate communications channel.

13. The method as recited in claim 10, wherein the receiver device and the laser source devices are in separate locations, and wherein each laser source device is observing a respective target that is also observed by the receiver device.

14. The method as recited in claim 13, further comprising displaying each respective pulsed optical signal overlaid on an image that includes each of the respective targets.

15. The method as recited in claim 14, further comprising displaying indicia of a respective communication associated with each pulsed optical signal.

16. An optical communication receiver device comprising:
an optical receiver component configured to receive at least one pulsed optical signal through free space, wherein the at least one pulsed optical signal is received from at least one laser source device; and
a module operatively connected to the optical receiver component, wherein the module is configured to decode data encoded in the at least one pulsed optical signal from the receiver component, wherein decoding is performed asynchronously with respect to the at least one laser source device.

17. The device of claim 16, further comprising a display operatively connected to the module, wherein the module and display are configured to display the pulsed optical signal overlaid on an image of the target observed by both the optical receiver component and the laser source device.

18. The device of claim 17, wherein the display and module are configured to display indicia of a communication associated with the pulsed optical signal.

19. The device of claim 16, wherein the at least one pulsed optical signal is a plurality of pulsed optical signals from a plurality of laser source devices.
